(19) United States
(12) Patent Application Publication
(10) Pub. No.: US 2006/0176966 A1
(43) Pub. Date: Aug. 10, 2006

(54) Variable cyclic prefix in mixed-mode wireless communication systems

(76) Inventors: Kenneth A. Stewart, Grayslake, IL (US); Robert T. Love, Barrington, IL (US)

Correspondence Address: MOTOROLA INC, 600 NORTH US HIGHWAY 45, ROOM AS437, LIBERTYVILLE, IL, 60048-5343, US

(21) Appl. No.: 11/052,700

(22) Filed: Feb. 7, 2005

(51) Int. Cl. H04K 1/10

(52) U.S. Cl. 375/260

(57) ABSTRACT

A method in a wireless communication network infrastructure entity (200), including transmitting a plurality of symbols in a sequence, some of the symbols associated with a first transmission mode, for example, point-to-point, and some other symbols associated with a second transmission mode, for example, point-to-multipoint, different than the first transmission mode. And formatting the symbols associated with the first transmission mode with a first cyclic prefix and formatting the symbols associated with the second transmission mode with a second prefix, before transmitting the symbols. In one embodiment, the cyclic prefixes have different durations.

### FIELD OF THE DISCLOSURE

The present disclosure relates generally to wireless communications, and more particularly to mixed-mode wireless communications protocols where a sub-sequence of symbols in a frame is broadcast to multiple recipients and other sub-sequences of symbols in the frame are transmitted to a single recipient, networks and devices and corresponding methods.

### BACKGROUND OF THE DISCLOSURE

Selected modulation types, including Orthogonal Frequency Division Multiplexing (OFDM), Interleaved Frequency Division Multiplexing (IFDM) and single carrier modulation among others may utilize so-called “cyclic prefix” (CP) methods in link construction. The CP is used chiefly to simplify equalizer design and implementation in the receiver. The primary purpose of the equalizer is to permit reception of modulated symbols under multi-path channel conditions, i.e., where the channel is time-dispersive. Viewed another way, the CP can render the linear transformation defined by the transmission of a modulation symbol through a multipath channel to be a circular rather than a conventional convolution operation. This is particularly effective for modulation types, such as OFDM and IFDM, constructed in the frequency domain from a component set of frequency tones or subcarriers, since the resulting equalization operation may be viewed as a transformation of each received subcarrier by a single complex-valued scalar.

One approach to designing a cyclic prefix (CP) that achieves the aforementioned result is to copy a portion of the time-domain symbol payload-bearing portion of length Tᵤ, having a guard interval of length T_{g}, at one end of a symbol to the start of the symbol as illustrated in prior art FIG. 1. Other approaches to CP design are also feasible, including the so-called cyclic postfix where the CP is appended rather than prefixed to the payload portion of the symbol, each offering different design compromises at the transmitter and receiver. The CP reduces throughput, however, in proportion to T_{g}/Tᵤ, since the CP provides no new information. It is thus desirable to minimize the CP duration T_{g}, but this must be done consistent with the general requirement that the CP duration should exceed the largest delay of any significant multipath channel component as discussed further below. Note that in some circumstances it may be optimal in terms of throughput to permit the CP duration be less than the largest delay of the multipath channel, but the general rule remains that the CP duration should scale in proportion to the multipath channel delay, and so the simpler guideline that the CP duration should simply exceed the multipath channel delay is used in what follows.

In a cellular or multi-site communication network, a number of different types of transmissions are possible. A point-to-point (unicast) transmission occurs where a single site transmits to a single user station. This may be augmented by downlink macro-diverse transmissions, where several sites transmit to the user station, but nevertheless, the transmission from the network is directed towards a single user station. In a point-to-multipoint (multicast) transmission, a single site transmits to multiple user stations constituting a subset of all user stations in the network. In broadcast transmissions, one or more sites transmit to all or a subset of user stations in the network. Broadcast therefore includes multicast transmission. In broadcast systems, while the fundamental information content of data transmitted by each site is identical, the modulated symbol stream transmitted from each site may be different. Simulcast is a broadcast transmission where the modulated symbol stream transmitted by each site is identical and where the frequency, synchronization (timing), and amplitude of the waveform transmitted by each site are coordinated. In simulcast systems, the resulting received waveform may be viewed as equivalent to the transmission of a single frame of symbols through the sum of the multipath channels (including propagation delay) between the terminal and each of the simulcasting transmitters. A simulcast network is sometimes also referred to as a Single Frequency Network (SFN).

In order for the cyclic prefix (CP) to be effective for point-to-point (unicast) applications, the length or duration, T_{g}, of the CP must be greater than or equal to the delay, Tₘ, associated with the largest significant delay of the multipath channel associated with the link from the single serving transmitter to the terminal. A multipath component that exceeds the length of the CP can be a source of self-interference at the receiver (depending on the receiver architecture), thereby reducing the achievable signal to interference and noise ratio (SINR) and in turn resulting in poorer receiver performance exhibited for example as increased bit and frame error rates, reduced sustainable transmission bit rates in rate-adapting networks, etc.

A multipath component having a relatively small amplitude compared to the component having the largest amplitude is considered insignificant and is not used in determining the multipath delay, Tₘ. The propagation delay between the transmitter and the receiver is, however, generally included in the delay definition. In unicast systems, the contribution of the propagation delay, Δτ, to the delay, Tₘ, may be substantially neglected since the receiver may adjust its timing reference, or receive window, to match the single observed transmission timing delay. In the simulcast case, however, the receive window may be established with respect to, say, the nearest transmitter, i.e., the transmitter with minimum propagation delay, or it may be established with respect to the transmitter with the strongest or highest SNR multi-path component. In simulcast systems, the delay attributable to multipath components observed from more distant simulcasting transmitters is the sum of the delay due to multipath effects and that due to differential propagation delay, Δτ i.e., the difference in propagation delay between the transmitter used to establish the receiver timing reference and the delay of the most distant simulcasting transmitter.

The maximum delay, Tₘ, observed by a receiver in unicast systems where multipath delay predominates can be significantly less than in broadcast or simulcast systems where differential propagation delay is predominant. In cellular communication system deployments, the maximum differential path delay, Δτ and the maximum multipath component delay may have significantly different values. In a macrocellular deployment with an inter-site distance of 2800 m, for example, the maximum typical differential propagation delay is approximately 9.3 μs. At the same time, using the International Telecommunications Union (ITU) Vehicular A multipath channel as an example, the delay at which the multipath component is 10 dB smaller than the dominant multipath component is only approximately 1 μs. Designing the cyclic prefix (CP) length to be the same for both unicast and broadcast systems, obeying the requirement: T_{g}≧max(Tₘ, Δτ), is therefore inefficient.

Known OFDM-based systems such as digital video broadcast (DVB), including DVB-T and DVB-H, and IEEE 802.16e support a set of cyclic prefix (CP) duration values, with the fraction T_{g}/Tᵤ of the total OFDM burst assigned to the CP selected from the set T_{g}/Tᵤ{1/32, 1/16, 1/8, 1/4}. This permits the CP duration to be matched to the channel delay, Tₘ, and for the associated CP overhead to be minimized. However, the process of selecting the operational CP from the set of available CP's is done only once during the initial network configuration. Thereafter, the CP remains unchanged.

In some networks, a single base station transmits within a frame in both unicast and broadcast modes, wherein a continuous sub-sequence of symbols in the frame are broadcast to multiple recipients (broadcast zone) and other continuous sub-sequences of symbols in the frame are transmitted to a single recipient (unicast zone). Such a scheme is supported by, among others, the IEEE 802.16e protocol, which is an extension to the IEEE 802.16d specification, otherwise known as the IEEE 802.16-2004 (802.16d) specification. IEEE 802.16e specifies a constant CP length for both modes, that is, for both the unicast and multicast zones. As discussed above, designing the CP length to be the same for both modes is inefficient since the single CP length is driven by the maximum of the multipath channel time delays observed over both modes of operation, i.e., obeying the requirement: T_{g}≧max(Tₘ, Δτ).

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is a prior art symbol with a pre-pended cyclic prefix.

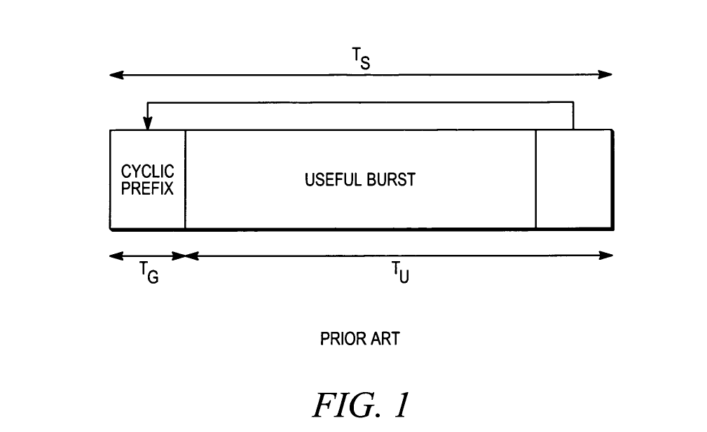

FIG. 2 is an exemplary architecture for formatting symbols with a cyclic prefix.

FIG. 3 illustrates symbol puncturing to accommodate a cyclic prefix without increasing frame length.

FIG. 4 illustrates symbol payload reduction without reducing symbol count.

### DETAILED DESCRIPTION

The disclosure pertains generally to wireless communication network infrastructure entities that transmit symbols formatted with a cyclic prefix in a sequence to fixed-base or mobile wireless terminals. The symbols are generally transmitted in a sequence of symbols, for example, as frames. Exemplary communication systems include cellular networks and wireless local area networks (WLANs) using modulation formats that benefit from use of a cyclic prefix. Exemplary modulation formats include, but are not limited to, orthogonal frequency division multiplexing (OFDM), Interleaved Frequency Division Multiplexing (IFDM), Code Division Multiple Access (CDMA), single carrier modulation, among others.

The symbols are generally formatted with the cyclic prefix at a network infrastructure entity, for example, at a base station in a cellular communication network or at an access point (AP) in a wireless local area network or at some other network infrastructure entity. The disclosure contemplates any cyclic prefix or suffix construction. The term “cyclic prefix” as used herein encompasses cyclic prefixes and suffices pre-pended, appended or otherwise attached or formatted with a symbol, including the case where a cyclic prefix comprises a null transmission, i.e., where no symbol is transmitted, among others.

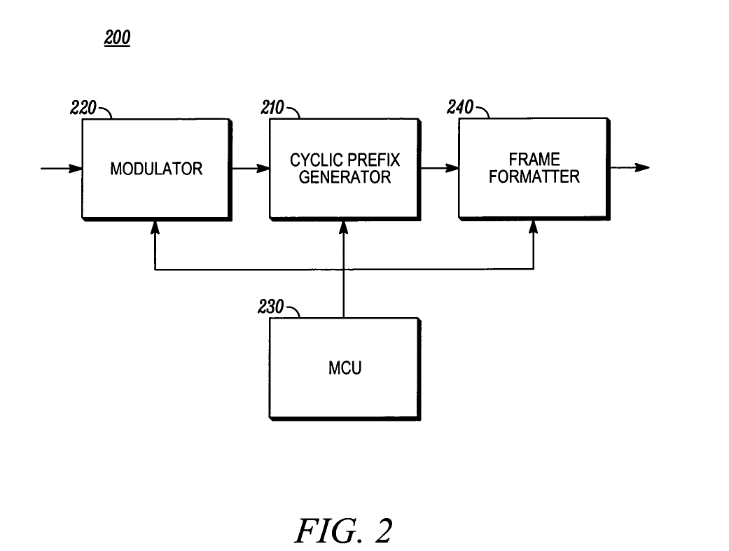

In FIG. 2, an exemplary network infrastructure entity architecture 200 formats symbols with a cyclic prefix. The architecture of FIG. 2 includes generally a cyclic prefix generator 210 that generates cyclic prefixes for formatting symbols output by a modulator 220. The modulator 220 provides symbols in a sequence to the cyclic prefix generator, which generates and adds a cyclic prefix to each symbol under control of a controller (MCU) 230, which is discussed further below. The modulator output is dependent on the particular modulation format implemented, examples of which were discussed above. Generally the symbols output by the modulator 220 have a characteristic payload.

In some embodiments, a sequence of symbols constitutes one or more time-slots or frames. These frames may also have non-payload bearing symbol types embedded within it, for example, pilot symbols provided for multipath channel estimation purposes at the receiver, or other symbols of known content which may serve as synchronization symbols, among others. For example, in communication systems where each symbol comprises a specific number of sub-carriers, the nominal number of which is defined equal to the length of the component Discrete Fourier Transform (DFT) or Fast Fourier Transform (FFT) used to construct the underlying modulation symbol, it is generally recognized that not all of the N sub-carriers defined may be active.

In mixed mode applications, some of the symbols in the sequence are transmitted by one mode, for example, by point-to-point transmissions, and other symbols of the sequence are transmitted by another mode, for example, by point-to-multipoint transmissions, including broadcast, multicast and simulcast, which is also known as Single Frequency Network (SFN), transmissions. In some embodiments, the mixed mode transmissions, for example, unicast and broadcast transmissions, are transmitted on a common carrier. In other embodiments, the mixed mode transmissions are transmitted on separate carriers, for example, point-to-point transmissions are on one carrier and point-to-multipoint transmissions are on another separate carrier.

In some mixed mode embodiments, symbols associated with a first transmission mode are formatted with a first cyclic prefix and symbols associated with a second transmission mode with a second prefix, wherein a characteristic of the first and second cyclic prefixes is different. In one embodiment, the symbols associated with the first and second transmission modes are distinguished by different cyclic prefix durations. For example, symbols transmitted by broadcast mode are formatted with a cyclic prefix having a longer duration than the duration of the cyclic prefix applied to symbols transmitted by unicast mode.

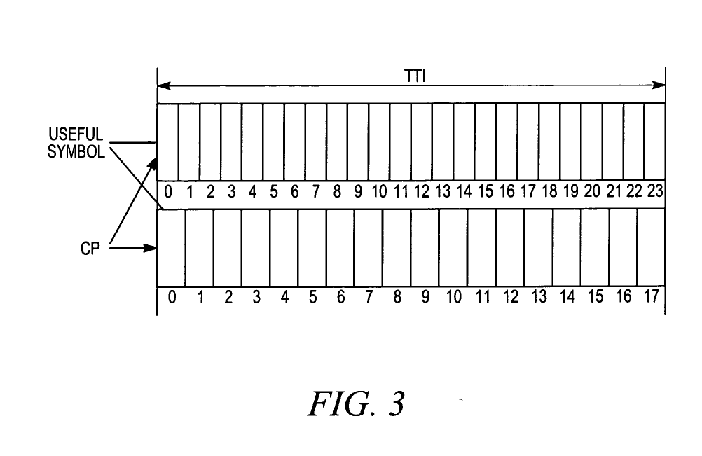

In FIG. 3, the controller 230 sends signals to the generator 210 indicating the mode by which symbols received from the modulator 220 will be transmitted. The cyclic prefix generator 210 formats the symbols with a cyclic prefix having duration dependent on the mode by which the formatted symbol will be transmitted. The generator thus changes or adjusts the cyclic prefix duration dependent on the mode by which the symbol will be transmitted. More generally, the cyclic prefix generator may change or adjust other characteristics of the cyclic prefix, in addition to or instead of the cyclic prefix duration.

In some embodiments where multiple symbols constitute a frame, the frame is comprised of symbols transmitted by more than one mode, for example, by unicast and broadcast modes. In these exemplary embodiments, the generator 210 dynamically formats each symbol of the frame with a cyclic prefix having a corresponding duration dependent on the mode by which the symbol will be transmitted. In embodiments where multiple symbols constitute a frame, the frame is comprised of symbols transmitted by not more than one mode, for example, by unicast mode only or by broadcast mode only. In these exemplary embodiments, the generator 210 dynamically formats the symbols of each frame with a cyclic prefix having a corresponding duration dependent on the transmission mode of the frame.

In some embodiments, the number of symbols comprising the frame may be reduced, or punctured, to permit an expansion of the CP duration allocable to each symbol in order to satisfy a frame length constraint. Puncturing also permits satisfying a frame length constraint without reducing the payload of each of the symbols constituting the frame. In FIG. 2, puncturing occurs at the frame formatter entity 240 in response to control signals from the controller 230.

FIG. 3 illustrates an exaggerated example where a 24-symbol frame is modified to 18 symbols to accommodate a longer CP duration while satisfying a frame length constraint without reducing the payload of the remaining symbols. More specifically, for a unicast-mode frame comprising P symbols of duration Tₛ=Tᵤ+T_{gu}, where T_{gu} is the CP duration in unicast mode, the total frame duration T_{f} is given by T_{f}=PTₛ. When frames of the broadcast type are transmitted, the frame duration remains the same, but the total number of transmitted symbols is modified to Q symbols, where Q<P. That is, R=P−Q symbols are punctured from the nominal frame symbol content. The resulting total duration available per symbol T_{sb} is then given by T_{sb}=T_{f}/Q. Since the payload duration per symbol remains constant at value Tᵤ, the resulting CP duration T_{gb} in broadcast mode is T_{gb}=T_{sb}−Tᵤ, where T_{gb}>T_{gu}. Where regions of a frame are respectively allocated to unicast and broadcast mode, the same approach of puncturing the symbol content in the region allocated to broadcast mode may be applied as discussed above. The approach of taking the broadcast frame type, or broadcast region as a reference, and subsequently inserting additional symbols into the unicast frame or frame region is an equivalent procedure.

In one exemplary embodiment, an OFDM system having an exemplary “chip rate” of 6.52 Ms/s, a length-512 Fast Fourier Transform (FFT), and 24 OFDM symbols per 2 ms TTI includes a total of 13056 chips per TTI and supports a CP duration of 4.9 us per frame. An additional 1088 (2*{512+32}) chips may be obtained by reducing or puncturing the 24 symbol frame to 22 symbols. The resulting CP duration per symbol is increased to 12.5 us, which exceeds some broadcast requirements.

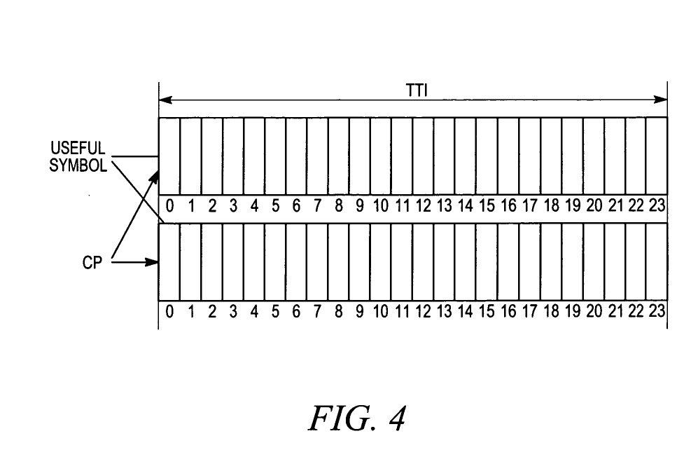

Another approach to extending the duration of the CP is to reduce the length Tᵤ of the associated useful symbol duration (payload), thereby permitting an increase in the CP duration. Reducing the symbol payload permits satisfying a frame length constraint without reducing the number of symbols constituting the frame. In FIG. 2, payload reduction occurs in the modulator 220 in response to control signals from the controller 230. Payload reduction may also be used in combination with puncturing discussed above. In FIG. 4, if payload reduction is the only means employed, the frame formatter entity may not be required.

For modulation types based on frequency-domain methods including OFDM and IFDM, among others, the symbol payload may be reduced by shortening the duration of the underlying Fast Fourier Transform (FFT) or Discrete Fourier Transform (DFT) operation performed at the modulator, for example modulator 220 in FIG. 2, in response to the control signal. For example, the useful symbol period may be shortened from 512 to 458 chips in a 24 symbol frame to create 54 more chips resulting in a duration of approximately 13 us per symbol. Equivalently, the length of the orthogonal basis function set of order N comprising the symbol may be reduced. This approach preserves the orthogonality of the basis set at the expense of a reduced number of Quadrature Amplitude Modulation (QAM) symbols transferred in the symbol payload. Alternatively, the symbol payload duration may be reduced by puncturing the underlying basis functions from length-N to length-M sequences, where M<N. This latter approach preserves the QAM symbol count transferred per OFDM symbol, but results in a loss of orthogonality of the underlying modulation.

In some embodiments, the frame duration may be extended to accommodate symbols formatted with a cyclic prefix having longer durations without reducing the number of symbols in the frame and without reducing the payload of the symbols. In embodiments where the symbols have complementary uplink and downlink cycles, a cyclic prefix having a longer duration may be accommodated by increasing the cycle in which the cyclic prefix formatted symbol is located and decreasing the complementary cycle: For example, downlink cycle of a symbol may be increased to accommodate a specific cyclic prefix duration, and the uplink cycle may be decreased accordingly so that sum of the uplink and downlink cycles remains constant. These schemes may be used alone or in combination with each and/or with the other schemes discussed above.

Several methods can be defined for notifying recipient terminals of which frames and symbols will carry broadcast and/or unicast transmissions, for example, notification using a resource mapping as discussed further below. This, in turn, permits the terminal to predict which symbols will utilize modified cyclic prefix durations. In one embodiment, the wireless communication network infrastructure entity, for example, a cellular base station or a WLAN Access Point (AP), transmits information from which a recipient of the symbols may determine the cyclic prefix characteristic, for example, the CP duration, of the symbols having an extended duration. More generally, this scheduling information may be transmitted by some other wireless communication device, for example, by a mobile terminal or a device constituting an ad hoc network. In some embodiments, the source of the scheduling information is the same as the source of the data, and in other embodiments the scheduling information is obtained from another source. A priori knowledge of the transmission mode of the symbols implies a cyclic prefix characteristic, for example, duration, assuming the recipient terminal knows the cyclic prefix duration for the different modes.

In one embodiment, the information from which a recipient of the symbols may determine the cyclic prefix characteristic is in the form of a mapping or other identification of frames comprising broadcast symbols and/or unicast symbols. Alternatively, this information may identify regions within frames where broadcast symbols and/or where unicast symbols are located. Alternatively, the information may indicate when the cyclic prefix characteristic changes. Thus by identifying whether the symbols were transmitted using broadcast or unicast mode or when the cyclic prefix duration or other characteristic changes, the recipient will have a priori knowledge of the cyclic prefix duration or other characteristic of each symbol received, thereby enabling proper synchronization and demodulation.

In one embodiment, mapping or scheduling information from which a recipient of the symbols may determine the cyclic prefix characteristic of at least some of the symbols is transmitted to the recipient at one or more instances. In one embodiment, this information is transferred when the recipient terminal attaches to a network, or subscribes to a service, for example, to a broadcast service, or upon the occurrence of some other event. In these exemplary embodiments, this information is provided to the recipient terminal before the terminal begins receiving the symbols or at least before the terminal must demodulate the signals. In some embodiments, the information is transmitted via L3 or L2 signaling. It may be transferred on a common or dedicated control channel, for example, in response to a recipient terminal's request transferred on a so-called Random Access Channel (RACH).

In another embodiment, the scheduling or mapping information is transferred when the recipient terminal requests the information, for example, a broadcast service. Possible methods for the terminal to make a service request and feedback broadcast quality information, e.g., based on SNR threshold or FER level threshold, includes cases where the terminal uses the RACH channel in portion of uplink frame, or where the RACH channel occupies an entire frame, or series of frames, and where the initial RACH channel access attempt is performed by pseudo-randomly selecting one of a set of predefined sequences, and/or where the terminal uses uplink frames corresponding to downlink broadcast frames to indicate broadcast requests and quality reports where different uplink frequency locations (sub-carriers) are allocated to different user stations.

In one embodiment, this information is transmitted to the recipient terminal on a frame by frame basis or once every N frames via a common or dedicated signaling channel, wherein the information indicates the location of a specific symbol, symbols, or region of a symbol in that frame or local sequence of N frames reserved for the broadcast channel mapping. Alternatively, the scheduling information is transmitted to the recipient terminal when the CP characteristic, for example, the duration, changes, thus indicating when the terminal must process the different cyclic prefix duration.

In one embodiment, where some symbols in the sequence are transmitted in broadcast mode on a first carrier and other symbols in the sequence are transmitted in unicast mode on a second carrier, the wireless communication device sends an instruction to the recipient device on one of the first and second carriers to receive symbols on the other of the second and first carriers. For example, the instruction may be on a unicast transmission carrier to receive on a broadcast transmission carrier. The recipient device could be programmed to know in advance the cyclic prefix durations for the unicast transmissions on one carrier and the broadcast transmission on the other carrier.

In one embodiment, the channel mapping is identified in a static or semi-permanent manner such that user stations are programmed in the factory to identify the symbols associated with a specific broadcast channel, or where such a mapping is selected according to one of the schemes discussed above, from a pre-programmed table of mappings. Changes in the broadcast channel resource mapping (assuming a semi-static or dynamic mapping is used) would require an action time so that the entire network and relevant user stations could make the mapping change at the same time instant.

In another embodiment, the receiver may autonomously detect the cyclic prefix (CP) duration or a change in CP duration by inspecting the data comprising the receiver observations of the symbol CP and payload intervals. In one exemplary embodiment, the receiver hypothesizes the length of the CP, for example, by time-domain correlation, frequency-domain correlation, the use of higher-order statistics etc., and verifies the hypothesis by measuring the length of the portion of the received symbol observed to be circulant. Additionally, the receiver may use contextual information, such as the results of hypothesis tests on adjacent symbols, to identify the CP duration associated with a sequence of symbols.

While the present disclosure and what are presently considered to be the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a wireless communication network infrastructure entity, the method comprising:
transmitting a plurality of symbols in a sequence, some of the plurality of symbols associated with a first transmission mode and some other of the plurality of symbols associated with a second transmission mode different than the first transmission mode;
before transmitting, formatting the symbols associated with the first transmission mode with a first cyclic prefix and formatting the symbols associated with the second transmission mode with a second prefix, the first cyclic prefix different than the second cyclic prefix.

2. The method of claim 1, transmitting the plurality of symbols using a common carrier.

3. The method of claim 1,
formatting the symbols associated with the first transmission mode with the first cyclic prefix having a first duration, formatting the symbols associated with the second transmission mode with the second cyclic prefix having a second duration, the first duration different than the second duration.

4. The method of claim 1,
transmitting the symbols associated with the first transmission mode using broadcast transmission, transmitting the symbols associated with the second transmission mode using unicast transmission.

5. The method of claim 1, dynamically changing a characteristic of the cyclic prefix dependent on the transmission mode with which the symbol to be formatted is associated, the first and second cyclic prefixes distinguished by the characteristic changed.

6. The method of claim 1,
the plurality of symbols constituting at least one frame,
puncturing symbols from the frame to accommodate symbols formatted with a cyclic prefix so that the frame satisfies a frame length constraint after formatting.

7. The method of claim 1,
the plurality of symbols constituting at least one frame,
reducing a payload of the fixed number of symbols in the frame to accommodate symbols formatted with a cyclic prefix so that the frame contains a specified number of symbols and satisfies a frame length constraint after formatting.

8. The method of claim 1,
receiving cyclic prefix scheduling information indicative of which transmission mode symbols in the sequence are associated,
formatting the symbols with the cyclic prefix having the cyclic prefix duration based on the cyclic prefix scheduling information.

9. The method of claim 1,
the plurality of symbols constituting at least one frame having a fixed number of symbols,
extending the duration of the frame to accommodate symbols formatted with a cyclic prefix without reducing the number of symbols in the frame and without reducing the payload of the symbols in the frame.

10. The method of claim 1,
the plurality of symbols constituting at least one frame having complementary uplink and downlink cycles,
accommodating symbols formatted with a cyclic prefix having a longer duration by increasing the cycle in which the formatted symbols is located and decreasing the complementary cycle.

11. The method of claim 1,
transmitting at least one symbol in the sequence in a broadcast mode on a first carrier, transmitting at least one other symbol in the sequence in a unicast mode on a second carrier,
indicating on one of the first and second carriers to receive symbols on the other of the second and first carriers.

12. The method of claim 1,
transmitting the plurality of symbols constituting a plurality of frames,
at least one frame comprising at least one symbol associated with the first transmission mode and at least one other symbol associated with the second transmission mode.

13. The method of claim 1,
transmitting the plurality of symbols constituting a plurality of frames,
one frame comprising symbols only associated with the first transmission mode, and another frame comprising symbols only associated with the second transmission mode.

14. A method in a wireless communication device, the method comprising:
transmitting a sequence of symbols,
each symbol transmitted by one of at least two different transmission modes,
each symbol formatted with a cyclic prefix having a characteristic dependent on the mode by which the symbol is transmitted, the cyclic prefix characteristic different for different transmission modes;
before transmitting the symbols, transmitting information from which a recipient of the symbols may determine the cyclic prefix characteristic of at least some of the symbols.

15. The method of claim 14,
transmitting at least one symbol in the sequence in a broadcast mode, and transmitting at least one other symbol in the sequence in a unicast mode,
the symbol transmitted in the broadcast mode having a cyclic prefix duration longer than a cyclic prefix duration of the symbol transmitted in the unicast mode.

16. The method of claim 15,
transmitting the information from which a recipient of the symbols may determine the cyclic prefix characteristic of at least some of the symbols includes indicating where in the sequence symbols to be transmitted by at least one transmission mode are located.

17. The method of claim 14, transmitting the information from which a recipient of the symbols may determine the cyclic prefix characteristic of at least some of the symbols when a recipient terminal to which the information will be transmitted performs one of: attachment to the network, subscribes to a broadcast service, and requests the information.

18. The method of claim 14,
the sequence of symbols constitutes a plurality of frames,
transmitting, at least once every N frames, the information from which a recipient of the symbols may determine the cyclic prefix characteristic of at least some of the symbols.

19. A method in a wireless communication handset, the method comprising:
receiving a plurality of symbols in a sequence, each symbol transmitted by one of at least two different transmission modes,
each symbol formatted with a cyclic prefix having a cyclic prefix duration dependent on a mode by which the symbol is transmitted, the cyclic prefix duration different for the different transmission modes;
demodulating the symbols using a priori information of the cyclic prefix duration of each symbol in the sequence.

20. The method of claim 19,
obtaining the a priori information of the cyclic prefix duration of each symbol in the sequence in a communication received before receiving the plurality of symbols in the sequence.

21. The method of claim 19,
obtaining the a priori information of the cyclic prefix duration of each symbol in the sequence based on receiver observations of cyclic prefix and payload intervals of a symbol.

22. The method of claim 19,
obtaining the a priori information of the cyclic prefix duration of each symbol in the sequence transmitted on a first carrier in a communication received on a second carrier before receiving the plurality of symbols in the sequence transmitted on the first carrier.
